(19) United States
(12) Patent Application Publication
(10) Pub. No.: US 2024/0263710 A1
(43) Pub. Date: Aug. 8, 2024

(54) FLUID VALVE SYSTEM

(71) Applicant: Hanon Systems, Daejeon (KR)

(72) Inventors: Emma Michelle Grissom, Howell, MI (US); Edward William Sanders, III, Monroe, MI (US); Jason Dale Perkins, Dexter, MI (US); Sunil Kumar Harihar Onkarachari, Mississauga (CA)

(21) Appl. No.: 18/165,546

(22) Filed: Feb. 7, 2023

(51) Int. Cl. F16K 11/085; F16K 5/04

(52) U.S. Cl. CPC F16K 11/0853; F16K 5/0407; F16K 5/0414; F16K 5/0471; F16K 31/535

(57) ABSTRACT

A fluid valve system including a housing defining a plurality of flow paths and a flow control member moveably disposed and selectively positionable within the housing. The flow control member includes a passageway having a plurality of openings, wherein a cross-sectional shape of at least one of the openings of the passageway is non-circular. When the flow control member is in a first position, a flow of fluid through a first flow path is permitted. When the flow control member is in a second position, the flow of fluid through a second flow path is permitted. When the flow control member is in intermediate third positions between the first position and the second position, the flow of fluid through both the first flow path and the second flow path is permitted.

### FIELD

The disclosure relates to a fluid valve system, and more particularly to a fluid valve system having a flow control assembly which optimizes performance.

### BACKGROUND

Vehicle heat exchanges, such as radiators, have valves which are used to control the rate that a fluid such as coolant, for example, is allowed to flow through the system. With the increase in government mandated fuel economy regulations, companies are increasingly looking for new technology that will reduce the parasitic losses and improve efficiency of internal combustion engines. Furthermore, the introduction of hybrid and fully electric vehicle powertrains has introduced powertrain and thermal management complexities due to the need to control the temperature of batteries, inverter electronics, electric motors, etc. These trends lead to the need for more intelligently controlled fluid valve systems.

Conventional valve systems include diverter balls, cylinders, and the like to enable the heat exchangers to receive various intake and exhaust flows. As such, a single heat exchanger may function as a charge air cooler (CAC), exhaust gas recirculation (EGR) cooler, and heat recovery device. While these designs may provide adequate performance for proportional flow applications, they do have some drawbacks. For example, some conventional valve systems have a vertical inlet at a base of a diverter valve. This allows for a wider outlet to provide smooth blending of flow between two horizontal outlets positioned 90 degrees radially apart. With the vertical inlet, the inlet will not take up space on an outer diameter on a cylinder needed for the wider outlet and the inlet can remain in a stable position since it is located on a rotational axis of the cylinder. However, the vertical inlet on the cylinder typically requires a vertical inlet on a port housing of the valve system. The vertical inlet on the port housing, and fluid connections to that vertical inlet, consume valuable packaging space in a vehicle in relation to all of the other vehicle components mounted around the valve system.

Accordingly, it would be desirable to produce a fluid valve system wherein a size, weight, cost, and complexity thereof is minimized, while optimizing a performance thereof.

### SUMMARY

In concordance and agreement with the presently described subject matter, a fluid valve system wherein a size, weight, cost, and complexity thereof is minimized, while optimizing a performance thereof, have surprisingly been discovered.

In one embodiment, a flow control member for a fluid valve system, comprises: a main body; and at least one passageway formed in the main body having a plurality of openings, wherein a cross-sectional shape of at least one of the openings of the at least one passageway is non-circular.

As aspects of some embodiments, a cross-sectional area of one of the openings of the at least one passageway is relatively smaller than a cross-sectional area of another one of the openings of the at least one passageway.

As aspects of some embodiments, a cross-sectional area of one of the openings of the at least one passageway is relatively larger than a cross-sectional area of another one of the openings of the at least one passageway.

As aspects of some embodiments, a cross-sectional area of one of the openings of the at least one passageway is substantially equal to a cross-sectional area of another one of the openings of the at least one passageway.

As aspects of some embodiments, one of the openings of the at least one passageway is substantially coplanar with another one of the openings of the at least one passageway.

As aspects of some embodiments, one of the openings of the at least one passageway is configured to be at least partially open during all operating modes of the fluid valve system.

In another embodiments, a fluid valve system, comprises: a housing defining a plurality of flow paths; and a flow control member moveably disposed in the housing, wherein the flow control member is configured to selectively control a flow of at least one fluid through the fluid valve system, wherein the flow control member includes at least one passageway having a plurality of openings, and wherein a cross-sectional shape of at least one of the openings is non-circular.

As aspects of some embodiments, the housing includes at least one fluid inlet port and a plurality of fluid outlet ports.

As aspects of some embodiments, one of the fluid outlet ports is formed on the housing relative to another one of the fluid outlet ports formed on the housing at an angle of about 90 degrees.

As aspects of some embodiments, one of the fluid outlet ports and at least one of the at least one fluid inlet port and another one of the fluid outlet ports are coplanar.

As aspects of some embodiments, the flow control member is selectively positionable between a first position, a second position, and a plurality of third positions between the first and second positions.

As aspects of some embodiments, the flow control member, when in the first position, is configured to permit an entirety of the flow of the at least one fluid through a first flow path and militate against the flow of the at least one fluid through a second flow path.

As aspects of some embodiments, the flow control member, when in the second position, is configured to militate against the flow of the at least one fluid through a first flow path and permit the flow of the at least one fluid through a second flow path.

As aspects of some embodiments, the flow control member, when in one of the third positions, is configured to permit the flow of the at least one fluid through a first flow path and permit the flow of the at least one fluid through a second flow path.

As aspects of some embodiments, a cross-sectional area of one of the openings of the at least one passageway is relatively smaller than a cross-sectional area of another one of the openings of the at least one passageway.

As aspects of some embodiments, a cross-sectional area of one of the openings of the at least one passageway is relatively larger than a cross-sectional area of another one of the openings of the at least one passageway.

As aspects of some embodiments, a cross-sectional area of one of the openings of the at least one passageway is substantially equal to a cross-sectional area of another one of the openings of the at least one passageway.

As aspects of some embodiments, one of the openings of the at least one passageway is substantially coplanar with another one of the openings of the at least one passageway.

As aspects of some embodiments, the fluid valve system further comprises at least one sealing element disposed between the housing and the flow control member to form a substantially fluid-tight seal therebetween.

In another embodiments, a method of controlling fluid flow, comprises the steps of: providing a fluid valve system including a housing and a flow control member moveably disposed in the housing, wherein the flow control member includes at least one passageway having a plurality of openings, and wherein a cross-sectional shape of at least one of the openings is non-circular; and selectively positioning the flow control member to selectively control a flow of at least one fluid through the fluid valve system.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a flow control member for a fluid valve system according to an embodiment of the present disclosure;

FIG. 2 is a top plan view of the flow control member of FIG. 1;

FIG. 3 is a bottom plan view of the flow control member of FIGS. 1 and 2;

FIG. 4 is a side elevational view of the flow control member of FIGS. 1-3, showing a fluid passageway formed therein;

FIG. 5 is another side elevational view of the flow control member of FIGS. 1-4, showing the fluid passageway formed therein;

FIG. 6 is a top sectional view taken along section line A-A shown in FIG. 5;

FIG. 7 is a top plan view of a fluid valve system according to an embodiment of the present disclosure, wherein the fluid valve system includes the flow control member of FIGS. 1-5 oriented in a first position;

FIG. 8 is a right side elevational view of the fluid valve system of FIG. 7;

FIG. 9 is a side elevational sectional view of the fluid valve system of FIGS. 7-8 taken along section line B-B shown in FIG. 7;

FIG. 10 is a top sectional view of the fluid valve system of FIGS. 7-9 taken along the section line C-C shown in FIG. 8, showing a first operating mode thereof wherein the flow control member of FIGS. 1-5 is oriented in the first position with an entirety of a flow to a first fluid outlet port and no flow to a second fluid outlet port;

FIG. 11 is a top sectional view of the fluid valve system of FIGS. 7-9 taken along the section line C-C shown in FIG. 8, showing a second operating mode thereof wherein the flow control member of FIGS. 1-5 is oriented in a second position with no flow to the first fluid outlet port and an entirety of the flow to the second fluid outlet port;

FIG. 12 is a top sectional view of the fluid valve system of FIGS. 7-9 taken along the section line C-C shown in FIG. 8, showing a third operating mode thereof wherein the flow control member of FIGS. 1-5 is oriented in one of intermediate third positions between the first position and the second position with a greater partial flow to the first fluid outlet port and a lesser partial flow to the second fluid outlet port;

FIG. 13 is a top sectional view of the fluid valve system of FIGS. 7-9 taken along the section line C-C shown in FIG. 8, showing a fourth operating mode thereof wherein the flow control member of FIGS. 1-5 is oriented in one of intermediate third positions between the first position and the second position with a partial flow to the first fluid outlet port and a substantially equal partial flow to the second fluid outlet port; and

FIG. 14 is a top sectional view of the fluid valve system of FIGS. 7-9 taken along the section line C-C shown in FIG. 8, showing a fifth operating mode thereof wherein the flow control member of FIGS. 1-5 is oriented in one of intermediate third positions between the first position and the second position with a lesser partial flow to the first fluid outlet port and a greater partial flow to the second fluid outlet port.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

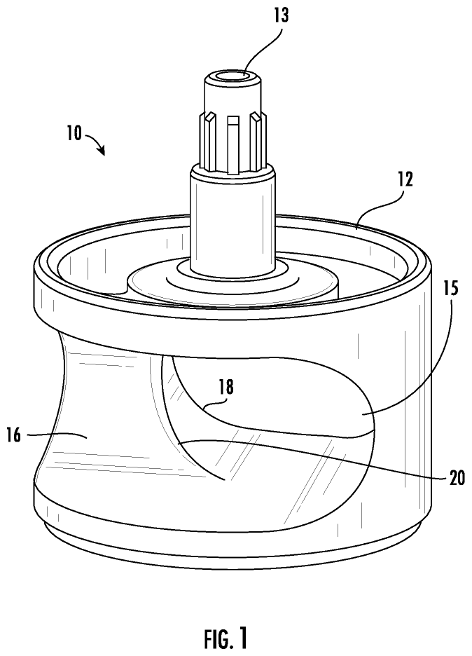

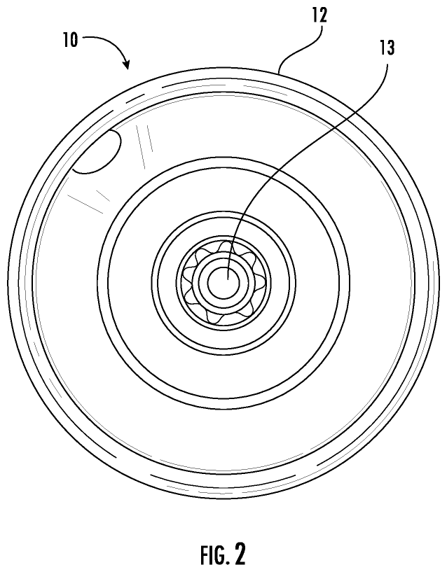

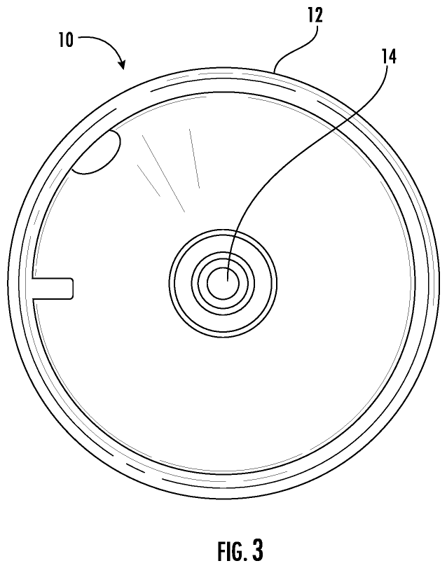

FIGS. 1-4 illustrate a flow control member 10 in accordance with an embodiment of the present disclosure. The flow control member 10 may be employed in a fluid valve system 100, which is described hereinafter. It should be appreciated that the flow control member 10 may be employed in other applications if desired. In preferred embodiments, the flow control member 10 may include a main body 12. The main body 12 has a generally cylindrical shape. However, it is understood that the main body 12 may have any suitable shape as desired. The main body 12 may be a unitary structure or formed from multiple components, if desired. It is also understood that the main body 12 may be formed from any suitable material such as a metal, a non-metal (e.g., plastic), and the like, or a combination thereof, for example. The main body 12 may be formed by a molding process, a three-dimensional printing process, a machining process, or any other forming process, or a combination thereof, as desired.

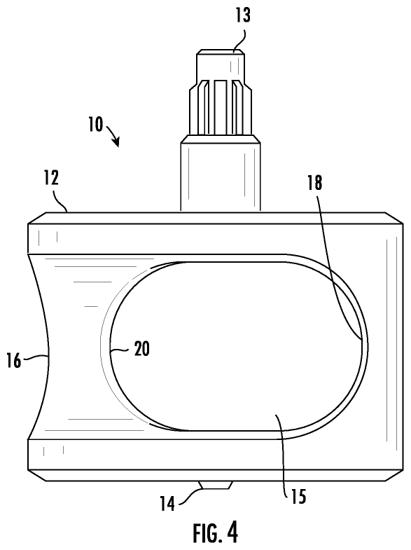

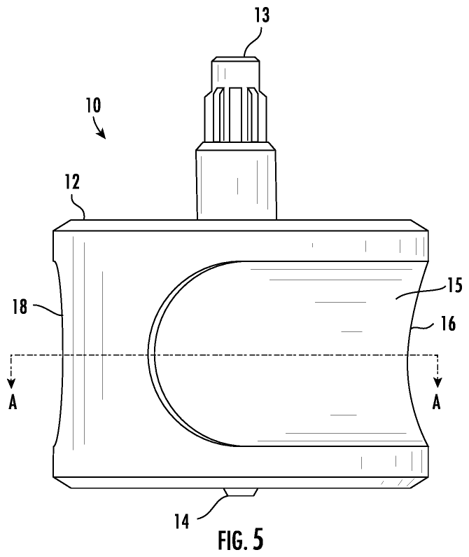

At least one driven element 13 (e.g., a driven gear, a pinion, etc.) and at least one positioning element 14 may be formed on the main body 12. As best seen in FIGS. 4 and 5, the driven element 13 and the positioning element 15 may extend outwardly and axially along a central axis of the main body 12. The driven element 13 may be configured to be coupled to a driving element or actuator (not depicted) to cause a rotational movement of the flow control member 10 in a first direction (e.g., clockwise) and an opposite second direction (e.g., counter-clockwise). It is understood that the driving element may be any component designed to cause rotational movement as desired. The positioning element 14 may be configured to cooperate with at least a portion of the fluid valve system 100, which is described hereinafter.

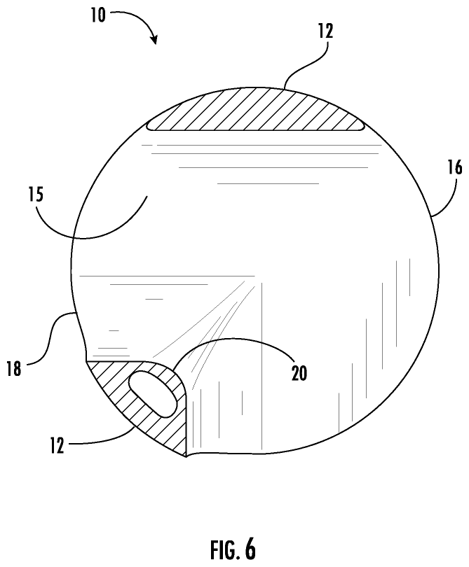

In some embodiments, the main body 12 has at least one fluid passageway 15 formed therein to receive a flow of a fluid therethrough. In some embodiments, the fluid passageway 15 may be generally T-shaped with a non-circular cross-sectional shape. The fluid passageway 15 may include a first fluid opening 16 and a second fluid opening 18, more clearly shown in FIG. 5. Additional fluid openings may be formed in the main body 12 if desired. Each of the fluid openings 16, 18 may function as a fluid inlet and/or a fluid outlet during operation of the fluid valve system 100. The first fluid opening 16 and the second fluid opening 18 may be substantially coplanar (i.e., on the same or a substantially similar plane (e.g., a horizontal plane, a transverse plane of the fluid valve system 100, etc.). As best seen in FIG. 6, a cross-sectional area of the fluid opening 16 may be larger than a cross-sectional area of the fluid opening 18. In certain embodiments, a cross-sectional shape of the first fluid opening 16 and/or the second fluid opening 18 may be non-circular. The non-circular cross-sectional shape of the fluid passageway 15 and/or one or more of the fluid openings 16, 18 facilitates proportional flow through the fluid valve system 100. Additionally, the non-circular fluid passageway 15 and/or fluid openings 16, 18 minimizes a pressure loss through the fluid valve system 100. It should be appreciated that the shape, size, and configuration of the main body 12 of the flow control member 10 including the fluid passageway 15 and openings 16, 18 results in simplified manufacture (e.g., a molding process, a three-dimensional printing process, a machining process, or any other forming process, or a combination thereof, as desired) and sealing structure of the fluid valve system 100.

In some embodiments, the fluid opening 16 may be configured to function as a fluid inlet and be at least partially open during all operating modes of the fluid valve system 100 to permit the flow of the fluid into the at least one fluid passageway 15. The fluid opening 16 may be configured to also function as a fluid outlet and be at least partially open during certain operating modes of the fluid valve system 100 to permit the flow of the fluid out of the at least one fluid passageway 15 and/or entirely closed during other certain operating modes of the fluid valve system 100 to direct the flow of fluid through the at least one fluid passageway 15 to the fluid opening 18. Further, the fluid opening 18 may be configured to function as a fluid outlet and be at least partially open and/or at least partially closed during the certain operating modes of the fluid valve system 100 to permit the flow of the fluid out of the at least one fluid passageway 15. A portion 20 of the fluid passageway 15 connecting the first fluid opening 16 and the second fluid opening 18 may also be curved.

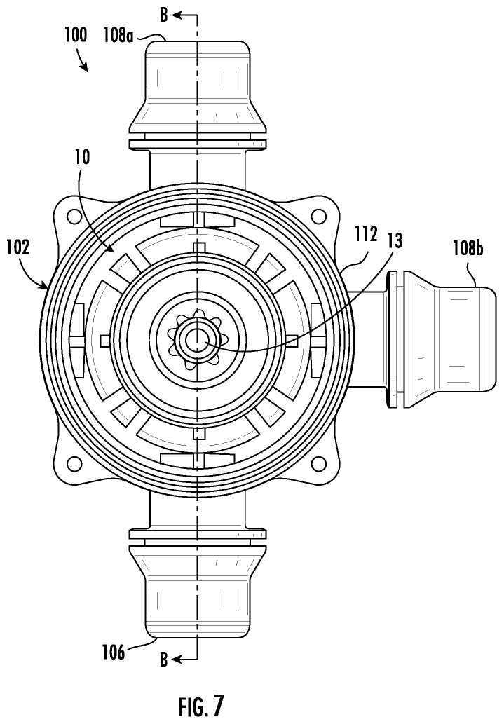

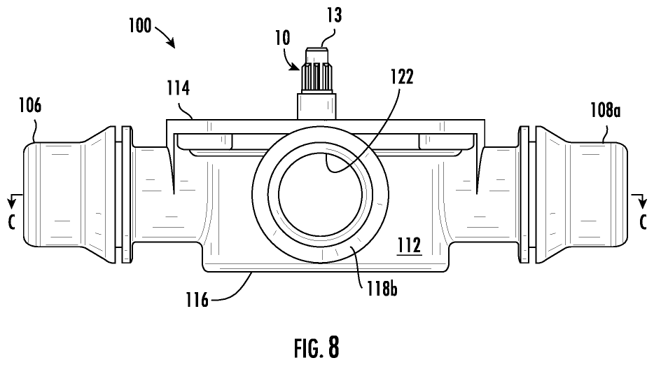

Referring now to FIGS. 7-14, an embodiment of the fluid valve system 100 including the flow control member 10 is shown. The fluid valve system 100 including the flow control member 10 may be employed in various applications such as proportional flow application, thermal energy exchange applications, and the like, for example. It should be appreciated that the fluid valve systems 100 may be employed in any suitable application as desired. The fluid valve system 100 may be in fluid communication with at least one fluid source (not depicted) for supplying at least one fluid (not depicted) and at least one fluid destination (not depicted) for receiving at least one fluid (not depicted).

In certain embodiments, the fluid valve system 100 may comprise a housing 102. As shown, the housing 102 may include at least one fluid inlet port 106 and a plurality of fluid outlet ports 108. The at least one fluid inlet port 106 may be in fluid communication with the at least one fluid source and each of the fluid outlet ports 108 may be in fluid communication with the at least one fluid destination. It is understood that the housing 102 may include more or less fluid inlet ports 106 and fluid outlet ports 108 than shown, if desired. It is further understood that each of the fluid inlet ports 106 may be in fluid communication with the same fluid source or separate and distinct fluid sources and each of the fluid outlet ports 108 may be in fluid communication with the same fluid destination or separate and distinct fluid destinations.

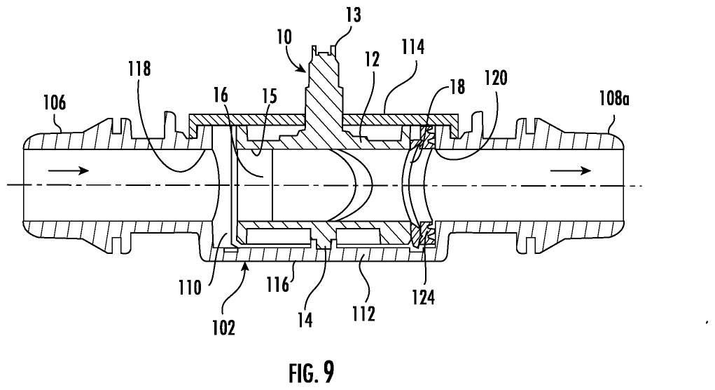

In some embodiments, one of the fluid outlet ports 108 and at least one of the at least one fluid inlet port 106 and another one of the fluid outlet ports 108 may be coplanar (i.e., lie on the same or a substantially similar plane (e.g., a horizontal plane, a transverse plane of the fluid valve system 100, etc.)). As a result, the flow of the fluid from the at least one fluid inlet port 106, into and through the flow control member 10, may be substantially parallel to the flow of the fluid from the flow control member 10 into the fluid outlet ports 108, as depicted in FIG. 9. Additionally, one of the fluid outlet ports 108 may be formed on the housing 102 at an angle relative to another one of the fluid outlet ports 108 formed on the housing 102, as best seen in FIGS. 7 and 10-14.

In an exemplary embodiment, the housing 102 may include the fluid inlet port 106 for receiving a fluid from a fluid source, a first fluid outlet port 108a for distributing the fluid to a first fluid destination, and a second fluid outlet port 108b for distributing the fluid to a second fluid destination. In one embodiment, the fluid outlet port 108a and the fluid outlet port 108b may lie on the same or a substantially similar plane (e.g., a horizontal plane, a transverse plane of the fluid valve system 100, etc.). In another embodiment, the fluid inlet port 106 and one of the fluid outlet ports 108a, 108b may lie on the same or a substantially similar plane (e.g., a horizontal plane, a transverse plane of the fluid valve system 100, etc.). In yet another embodiment, the fluid inlet port 106 and both of the fluid outlet ports 108a, 108b may lie on the same or a substantially similar plane (e.g., a horizontal plane, a transverse plane of the fluid valve system 100, etc.). As such, a size (e.g., a vertical packaging profile), weight, cost, and complexity of the fluid valve system 100 is minimized and a direct flow of the fluid through the fluid valve system 100 is permitted to minimize a pressure loss through the fluid valve system 100 and optimize a performance thereof.

In some embodiments, the fluid inlet port 106 may be formed on the housing 102 relative to the fluid outlet port 108a formed on the housing 102 at an angle of about 180 degrees and/or relative to the fluid outlet port 108b formed on the housing at an angle of about 90 degrees. The fluid outlet port 108a may be formed on the housing 102 relative to the fluid outlet port 108b formed on the housing 102 at an angle of about 90 degrees. Such angles between the fluid inlet port 106 and the fluid outlet ports 108a, 108b reduce the rotational movement of the flow control member 10 needed to travel therebetween. Additionally, the curved portion 20 between the fluid inlet portion 106 and the fluid outlet port 108 reduces friction and improves the flow of fluid from the at least one fluid inlet port 106 to the fluid outlet port 108a, which further minimizes the pressure loss through the fluid valve system 100 and optimizes the performance thereof.

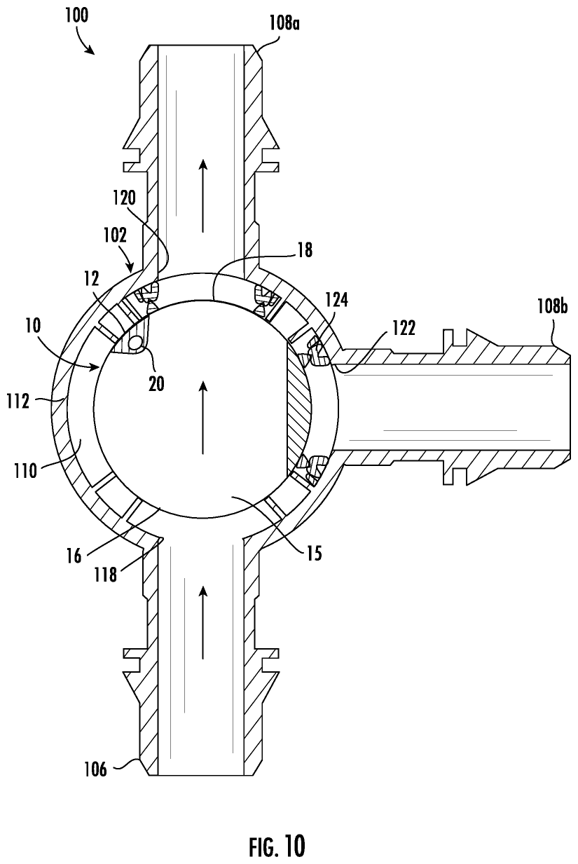

As illustrated in FIGS. 9-14, the housing 102 may include a chamber 110 defined by an outer wall 112 and opposing top and bottom walls 114, 116 (depicted in FIG. 9). It should be appreciated that the chamber 110 may have any size and shape as desired to receive the flow control member 10 therein. The flow control member 10 may be moveably disposed in the chamber 110 of the housing 102 so that the fluid opening 16 is generally aligned with the fluid inlet port 106 and the fluid opening 18 is generally aligned with the fluid outlet ports 108. As more clearly shown in FIGS. 10-14, the fluid inlet port 106 and the fluid outlet port 108b may be in fluid communication with the fluid openings 16, 18, respectively, of the fluid passageway 15 of the flow control member 10 through respective apertures 118, 122 formed in the outer wall 112 of the housing 102 and the fluid outlet port 108a may be in fluid communication with the fluid opening 18 of the fluid passageway 15 of the flow control member 10 through an aperture 120 formed in the outer wall 112 of the housing 102.

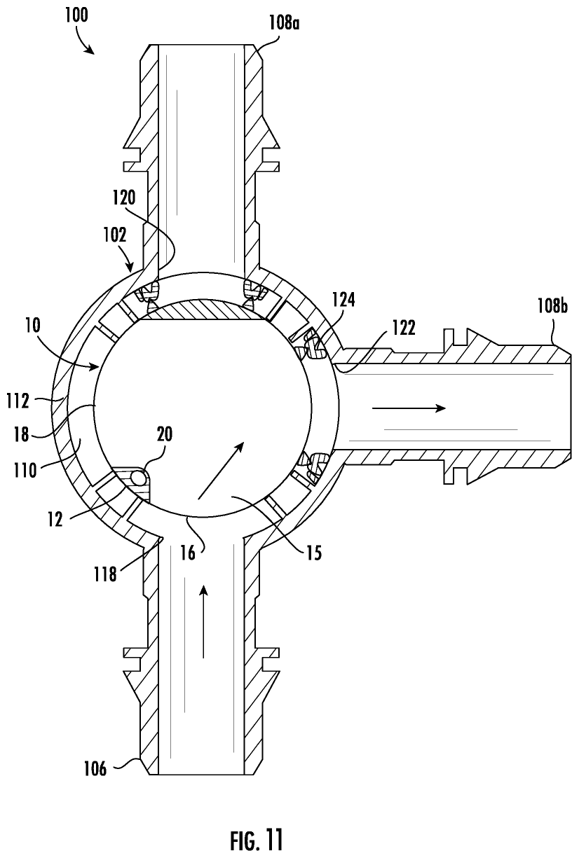

The flow control member 10 may be selectively positionable within the housing 102 of the fluid valve system 100 and configured to selectively control the flow of the fluid therethrough. A first flow path comprising the at least one fluid inlet port 106 of the housing 102, the fluid openings 16, 18 and the fluid passageway 15 of the flow control member 10, and the fluid outlet port 108a of the housing 102 is formed when the flow control member 10 is in the a first position as shown in FIG. 10. A second flow path comprising the at least one fluid inlet port 106 of the housing 102, the fluid opening 16 and a portion of the fluid passageway 15 of the flow control member 10, and the fluid outlet port 108b of the housing 102 is formed when the flow control member 10 is in the second position as shown in FIG. 11. Accordingly, the flow control member 10 may be configured to permit the flow of the fluid through the first flow path when in the first position, permit the flow of the fluid through a second flow path when in the second position, and permit the flow of the fluid through the first flow path and the second flow path when in one or more intermediate third positions between the first position and the second position.

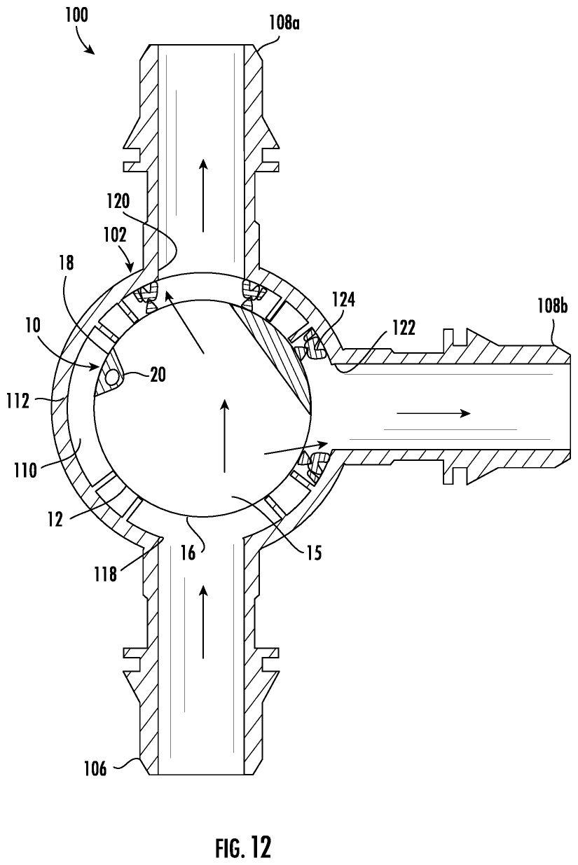

In a preferred embodiment, the flow control member 10 may be shaped and sized to cover an entirety of the aperture 122 while simultaneously leaving an entirety of the apertures 118, 120 uncovered when in the first position (depicted in FIG. 10), cover an entirety of the aperture 120 while simultaneously leaving an entirety of the apertures 118, 122 uncovered when in the second position (depicted in FIG. 11), and cover a portion of each of the apertures 120, 122 while simultaneously leaving a remaining portion of each of the apertures 120, 122 and the aperture 118 uncovered when in the intermediate third positions between the first position and the second position (depicted in FIGS. 12-14). By having the fluid outlet port 108a formed on the housing 102 relative to the fluid outlet port 108b formed on the housing 102 at an angle of about 90 degrees and/or with the relatively large cross-sectional area of the fluid opening 16 of the flow control member 10, the flow control member 10 may be selectively positioned so that the fluid opening 16 of the flow control member 10 remains in continuous fluid communication with the at least one fluid inlet port 106 of the housing 102, which permits the flow of fluid through the first flow path and/or the second flow path without interruption in the flow of fluid from the at least one fluid inlet port 106 into and through the fluid passageway 15 of the flow control member 10.

One or more sealing elements 124 (e.g. O-rings, gaskets, elastomeric seals, and the like), shown in FIGS. 9-14, may be disposed between the flow control member 10 and an inner surface of the housing 102 to form a substantially fluid-tight seal therebetween and militate against an undesired leakage of the fluid around a periphery of the ports 106, 108. It is understood that various other sealing methods may be employed if desired. It is further understood that more or less of the sealing elements 124 than shown may be employed as desired.

FIGS. 10-14 illustrate operating modes of the fluid valve system 100. In a first operating mode shown in FIG. 10, the flow control member 10 may be in the first position. When in the first position, the flow control member 10 covers the aperture 122 in fluid communication with the fluid outlet port 108b leaving the aperture 120 in fluid communication with the fluid outlet port 108a uncovered. Accordingly, an entirety of a flow of the fluid supplied by the fluid source may be permitted to flow through the first flow path to the first fluid destination and no flow is permitted through the second flow path to the second fluid destination.

In a second operating mode shown in FIG. 11, the flow control member 10 may be in the second position. In some embodiments, the flow control member 10 may rotate about 90° from the first position to the second position. When in the second position, the flow control member 10 covers the aperture 120 in fluid communication with the fluid outlet port 108a leaving the aperture 122 in fluid communication with the fluid outlet port 108b uncovered. Accordingly, an entirety of the flow of the fluid supplied by the fluid source may be permitted to flow through the second flow path to the second fluid destination and no flow is permitted through the first flow path to the first fluid destination.

In a third operating mode shown in FIG. 12, the flow control member 10 may be in one of the intermediate third positions between the first and second positions. When in the intermediate third position, the flow control member 10 covers a portion of the apertures 120, 122 in fluid communication with the fluid outlet ports 108a, 108b, respectively, leaving a remaining portion the apertures 120, 122 in fluid communication with the fluid outlet ports 108a, 108b uncovered. Accordingly, a greater partial flow (e.g., 75%) of the fluid supplied by the fluid source may be permitted to flow through the first flow path to the first fluid destination and a lesser partial flow (e.g., 25%) of the fluid supplied by the fluid source may be permitted to flow through the second flow path to the second fluid destination.

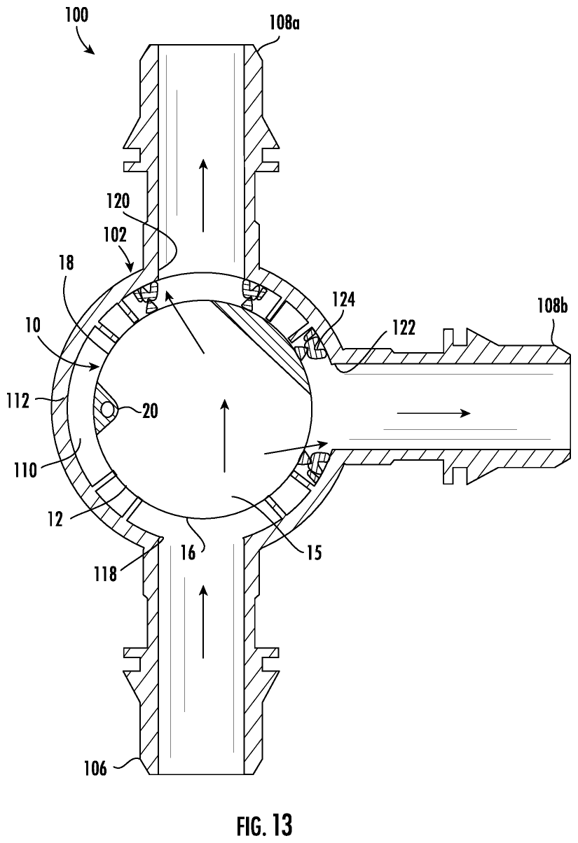

In a fourth operating mode shown in FIG. 13, the flow control member 10 may be in one of the intermediate third positions between the first and second positions. When in the intermediate third position, the flow control member 10 covers a portion of the apertures 120, 122 in fluid communication with the fluid outlet ports 108a, 108b, respectively, leaving a remaining portion the apertures 120, 122 in fluid communication with the fluid outlet ports 108a, 108b uncovered. Accordingly, a partial flow (e.g., 50%) of the fluid supplied by the fluid source may be permitted to flow through the first flow path to the first fluid destination and a substantially equal partial flow (e.g., 50%) of the fluid supplied by the fluid source may be permitted to flow through the second flow path to the second fluid destination.

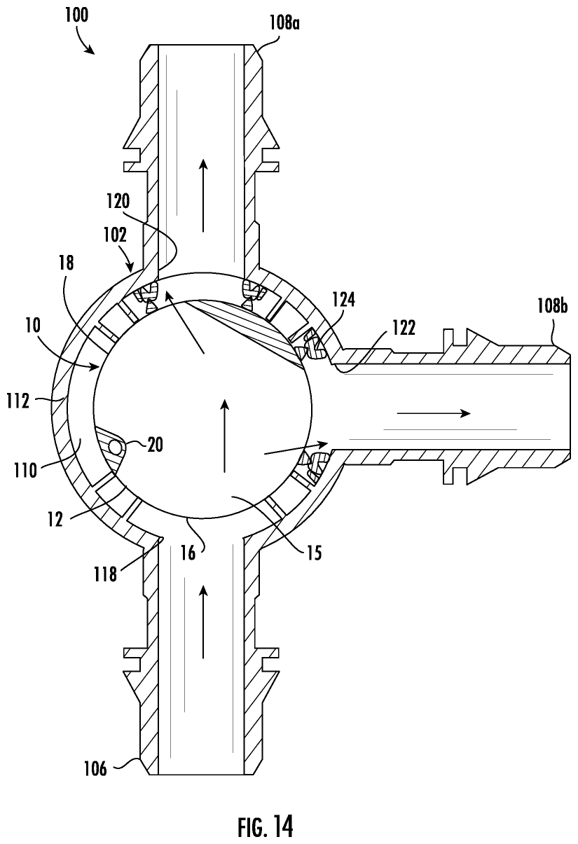

In a fifth operating mode shown in FIG. 14, the flow control member 10 may be in one of the intermediate third positions between the first and second positions. When in the intermediate third position, the flow control member 10 covers a portion of the apertures 120, 122 in fluid communication with the fluid outlet ports 108a, 108b, respectively, leaving a remaining portion the apertures 120, 122 in fluid communication with the fluid outlet ports 108a, 108b uncovered. Accordingly, a lesser partial flow (e.g., 25%) of the fluid supplied by the fluid source may be permitted to flow through the first flow path to the first fluid destination and a greater partial flow (e.g., 75%) of the fluid supplied by the fluid source may be permitted to flow through the second flow path to the second fluid destination.

In some embodiments, the fluid valve system 100 may further include the driving element or actuator. The driving element or actuator may be drivingly coupled to the driven element 13 to cause a rotational movement of the flow control member 10. The driving element or actuator may cause a rotational movement of the flow control member 10 in a first rotational direction (e.g. clockwise) and an opposite second rotational direction (e.g. counter-clockwise). More preferably, the driving element or actuator may cause the rotational movement of the flow control member 10 in the first rotational direction to selectively position the flow control member 10 between the first position and the second position, and in the second rotational direction to selectively position the flow control member 10 between the second position and the first position. The driving element or actuator may be powered by any electric motor with an ability to generate rotary motion. For example, the driving element or actuator may be driven by a stepper motor or a brushless DC (BLDC) motor. It is understood that other methods of actuation and causing the rotational movement of the flow control member 10 within the fluid valve system 100 may be used.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

1. A flow control member for a fluid valve system, comprising:
a main body configured to be disposed in a housing of the fluid valve system; and
a passageway formed in the main body configured to receive at least one fluid therethrough, the passageway having a first fluid opening and a second fluid opening, wherein the first fluid opening of the passageway is generally aligned with a fluid inlet port of the housing and configured to be at least partially open during all operating modes of the fluid valve system, and wherein the second fluid opening of the passageway is configured to be fully closed during at least one of the operating modes of the fluid valve system.

2. (canceled)

3. The flow control member of claim 1, wherein a cross-sectional area of the first fluid opening of the passageway is relatively larger than a cross-sectional area of the second fluid opening of the passageway.

4. (canceled)

5. The flow control member of claim 1, wherein the first fluid opening of the passageway is substantially coplanar with the second fluid opening of the passageway.

6. (canceled)

7. A fluid valve system, comprising:
a housing defining a plurality of flow paths, wherein the housing includes at least one fluid inlet port and a plurality of fluid outlet ports; and
a flow control member moveably disposed in the housing, wherein the flow control member is configured to selectively control a flow of at least one fluid through the fluid valve system, wherein the flow control member includes a passageway having a first fluid opening and a second fluid opening, wherein the flow of the at least one fluid is permitted through the first fluid opening of the flow control member during all operating modes of the fluid valve system, and wherein no flow of the at least one fluid is permitted through the second fluid opening of the flow control member during at least one of the operating modes of the fluid valve system.

8. (canceled)

9. The fluid valve system of claim 7, wherein one of the fluid outlet ports is formed on the housing relative to another one of the fluid outlet ports formed on the housing at an angle of about 90 degrees.

10. The fluid valve system of claim 7, wherein one of the fluid outlet ports and at least one of the at least one fluid inlet port and another one of the fluid outlet ports are coplanar.

11. The fluid valve system of claim 7, wherein the flow control member is selectively positionable between a first position, a second position, and a plurality of third positions between the first and second positions.

12. The fluid valve system of claim 11, wherein the flow control member, when in the first position, is configured to permit an entirety of the flow of the at least one fluid through a first flow path and militate against the flow of the at least one fluid through a second flow path.

13. The fluid valve system of claim 11, wherein the flow control member, when in the second position, is configured to militate against the flow of the at least one fluid through a first flow path and permit the flow of the at least one fluid through a second flow path.

14. The fluid valve system of claim 11, wherein the flow control member, when in one of the third positions, is configured to permit the flow of the at least one fluid through a first flow path and permit the flow of the at least one fluid through a second flow path.

15. (canceled)

16. The fluid valve system of claim 7, wherein a cross-sectional area of the first fluid opening of the passageway is relatively larger than a cross-sectional area of the second fluid opening of the passageway.

17. (canceled)

18. The fluid valve system of claim 7, wherein the first fluid opening of the passageway is substantially coplanar with the second fluid opening of the passageway.

19. The fluid valve system of claim 7, further comprising at least one sealing element disposed between the housing and the flow control member to form a substantially fluid-tight seal therebetween.

20. A method of controlling fluid flow, comprising the steps of:
providing a fluid valve system including a housing and a flow control member moveably disposed in the housing, wherein the flow control member includes a passageway having a first fluid opening and a second fluid opening; and
selectively positioning the flow control member to selectively control a flow of at least one fluid through the fluid valve system, wherein the flow of the at least one fluid is permitted through the first fluid opening of the flow control member during all operating modes of the fluid valve system, and wherein no flow of the at least one fluid is permitted through the second fluid opening of the flow control member during at least one of the operating modes of the fluid valve system.

21. The flow control member of claim 1, wherein the first fluid opening diametrically opposes the second fluid opening in the flow control member.

22. The flow control member of claim 1, wherein the first fluid opening is generally aligned with at least one fluid outlet port of the housing during at least one of the operating modes of the fluid valve system.

23. The fluid valve system of claim 7, wherein the first fluid opening of the flow control member is generally aligned with the at least one fluid inlet port of the housing during all of the operating modes of the fluid valve system.

24. The fluid valve system of claim 7, wherein the first fluid opening of the flow control member is generally aligned with at least one of the fluid outlet ports of the housing during at least one of the operating modes of the fluid valve system.

25. The method of claim 20, wherein the first fluid opening of the flow control member is generally aligned with the at least one fluid inlet port of the housing during all of the operating modes of the fluid valve system.

26. The method of claim 20, wherein the first fluid opening of the flow control member is generally aligned with at least one of the fluid outlet ports of the housing during at least one of the operating modes of the fluid valve system.
